(19) United States
(12) Patent Application Publication
(10) Pub. No.: US 2019/0394841 A1
(43) Pub. Date: Dec. 26, 2019

(54) VARIABLE TIME DIVISION MULTIPLEXING OF ELECTRIC FIELD MODES FOR ZONAL MICROWAVE COOKING

(71) Applicant: NXP USA, Inc., Austin, TX (US)

(72) Inventor: Gregory J. Durnan, Tempe, AZ (US)

(21) Appl. No.: 16/017,889

(22) Filed: Jun. 25, 2018

(51) Int. Cl. H05B 6/68; H05B 6/64

(52) U.S. Cl. CPC H05B 6/687; H05B 6/705; H05B 6/6455

(57) ABSTRACT

Embodiments include microwave cooking systems and methods of their operation, which are configured to heat food loads. Using a phased array, frequency and phase conditions and corresponding return losses are mapped in a cavity of the microwave cooking system. Using one or more thermal cameras, positions of E field maximums also are mapped in the cavity. The frequency and phase conditions are time division multiplexed so that heat maximums sum over a cooking cycle to provide a heating profile in a zone of interest.

### TECHNICAL FIELD

Embodiments of the subject matter described herein relate generally to microwave and radio frequency (RF) heating.

### BACKGROUND

Field uniformity, and therefore heating uniformity in a work load, is one of the grand challenges of microwave and radio frequency (RF) heating. The analytical basis for calculation of the fields within a cavity is well known and can be referenced in standard texts. For brevity, dielectric heating is of primary interest in cooking within a consumer (or commercial) microwave oven, and as such there is interest in the magnitude of the dissipated power due to an electric field impinging on the food being cooked (lossy dielectric material). From Poynting's theorem it is possible to state this directly as:

P_{d}=½ωε₀ε″|E|² (Equation 1)

where ω is the angular frequency in radians/seconds, ε₀ the permittivity of free space and ε″ is the imaginary component of permittivity. |E| is the magnitude of the impinging electric field.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a perspective view of a microwave cooking cavity with a 2-element phased array, according to an embodiment;

FIG. 2 illustrates a first depiction of an electric field summation in the microwave cooking cavity;

FIG. 3 illustrates a second depiction of an electric field summation in the microwave cooking cavity;

FIG. 4 illustrates a first heating profile in the microwave cooking cavity;

FIG. 5 illustrates a second heating profile in the microwave cooking cavity;

FIG. 6 illustrates a third heating profile in the microwave cooking cavity;

FIG. 7 illustrates a simplified depiction of a solid-state microwave cooking system, according to an embodiment;

FIG. 8 illustrates a schematic drawing of a two-channel synthesizer, according to an embodiment;

FIG. 9 illustrates a flowchart of a method for operating a solid-state microwave cooking system, according to an embodiment;

FIG. 10 illustrates a subset of an infrared (IR) scan showing power (E field position) as a function of phase and frequency; and

FIG. 11 illustrates a correlated return loss map as a function of phase and frequency.

### DETAILED DESCRIPTION

An electromagnetic wave can propagate within a cavity in a number of different modes. These modes include: 1) TE mode, in which the transverse electric waves (H waves) are characterized by the electric vector (E) being perpendicular to the direction of propagation; 2) TM mode, in which transverse magnetic waves (E waves) are characterized by the magnetic vector (H vector) being perpendicular to the direction of propagation; and 3) TEM mode, in which both the electric vector (E vector) and the magnetic vector (H vector) are perpendicular to the direction of propagation.

The field distribution in a resonant cavity (e.g., a microwave cooking cavity) depends on the number of modes that can be excited within a cavity. In practice though, only one mode may be excited at a single point in time, such that over a cooking cycle it is necessary to assign individual time slots for the mode being excited. Several strategies have been employed to excite multiple modes or disturb the dominant mode structure over the cooking period (e.g., using time slices or multiplexing over time of modes of interest), including turntables, mode stirrers and multiple waveguide feeds. Most of these strategies are frustrated by the lack of frequency and phase control associated with magnetron sources.

The advent of solid state sources, based on power amplifiers, allows novel cavity fed systems to be explored. One such feed system is a phased array of antenna elements. As will be described in more detail below, embodiments of the invention deal with work on loaded cavities when directly excited by phased array antennas, rather than waveguide driven magnetrons. The use of a multiple element phased array allows phasing of one antenna against another and access a number of modes that a single element cannot.

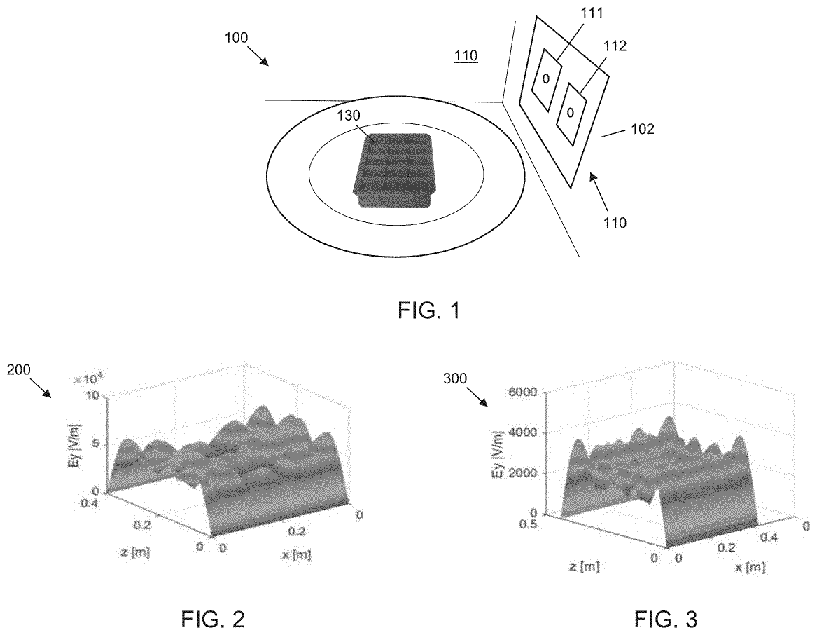

FIG. 1 is a perspective view of a portion of a microwave cooking cavity 100 with a 2-element 111, 112 phased array 110 on wall 102 (the right-side wall) of the cavity 100, according to an embodiment. Tray 130 is configured to contain a load within the cavity 100. According to an embodiment each element 111, 112 is phased against the other using a solid-state source.

The cooking cavity 100, with the phased antenna array feed 110 maximizes the number of accessible modes in the cavity 100. It should be noted that, while the number of modes may be maximized, not all modes may be excited by the phased array 110, due to such practicalities as the placement and number of feed antennas.

The cooking cavity interior dimensions may be optimized for a desired or a maximum number of intrinsic modes. For example, optimizing cooking cavity dimensions for the maximum number of intrinsic modes yielded a mode count of 24 individual modes (TE and TM) for a cavity of depth=43 centimeters (cm), width=44 cm and height=26 cm. These may include both TE/TMₘₙₚ modes, some of which may be degenerate modes.

Equations of electric fields (E fields) for both TE and TM modes may be calculated (e.g., in Matlab). FIG. 2 illustrates an E field summation 200 in a cavity (e.g., cavity 100), and more specifically shows a dip in the center of the E field summation. In FIG. 2, the results are the sum of 24 intrinsic modes (as calculated in Matlab) for an ideal cavity independent of applicator.

According to an embodiment, with a 2-element phased array patch antenna on the side wall (e.g., in the typical magnetron position) 12-14 modes (dependent on cooking load) are accessed in the 2.4-2.5 gigahertz (GHz) range for the cavity dimensions given previously. These mnp integer indices correspond to the xyz plane periodicity of either sine or cosine waves that defines the mode's standing wave pattern.

Through the complex addition of all modes in an ideal cavity (eigen modes for a given cavity size), a likely heating pattern for an empty cavity is shown in FIG. 2. It can also be shown that the use of optimization, in this case the use of simulated annealing with a fitness function that attempts to make the average electric field sum of all intrinsic modes of the cavity at defined points across the cooking space as flat as possible by minimizing the E field variation, produces a superior field distribution compared with a regular microwave oven.

The simulated annealing result, using just a few evenly weighted E field points across the cooking space as part of the minimized fitness function, may give a considerably improved field distribution. For example, this is shown in FIG. 3, which is an E field summation 300 in a cavity with simulated annealing (in Matlab) of the same ideal cavity and 24 intrinsic modes to optimize which modes to excite to yield a superior result in terms of evenness. It is envisaged that not only by selecting the correct modes but by giving some modes greater cook time than others can yield an even better result.

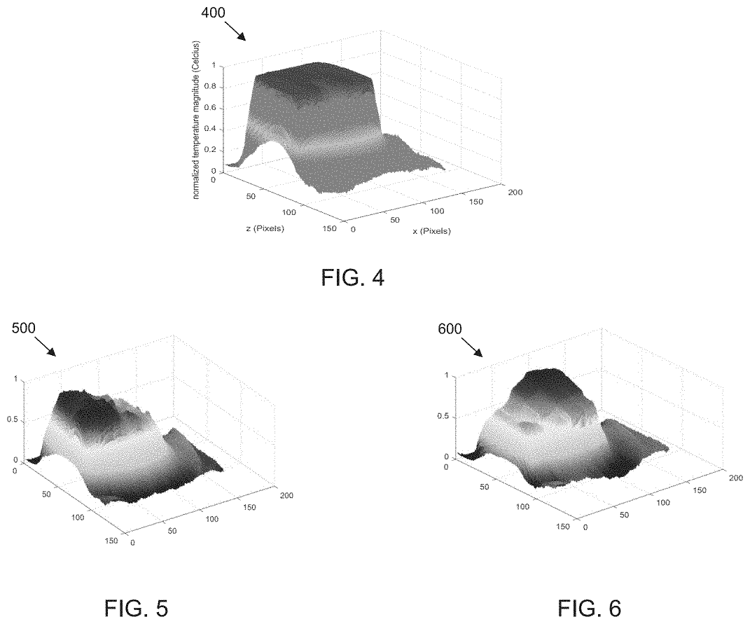

In a real cooking environment, a method of measuring points of high dielectric heating (due to high electric fields) in a load, albeit as a scalar heating pattern using a thermal camera (e.g., 120×160 pixel camera), will allow an adaptive phased array system (with the advantage of size and cost for a solid state system) to cycle through phase and frequency mapping so that modes are identified, that when summed, form a desired final heating pattern. An example of such a desired final heating pattern (even heating pattern) is shown in FIG. 4, which illustrates a real world heating profile 400 of 9% sodium chloride (NaCl) solution in a tray (e.g., tray 130, FIG. 1) as extracted using an infrared (IR) camera and manipulated using methods as per the analytical method discussed. The goal/fitness function was the minimization of the average of 15 temperature points. The resultant equation was found to be:

imc=(10*ima+imb)./11 (Equation 2)

FIG. 4 more specifically shows a normalized flat cooking profile 400 resulting from the irregular time slicing of several modes found during an IR and return loss correlation mapping exercise. For example, the irregular time slicing, in a simplified version of a cooking algorithm, may apply mode A at 10 times the slice rate of mode B. Power may be held constant for both modes, but may be subject to variability as per the food item.

This approach of correlating the camera heating data with RF parameters (e.g., time, frequency, phase, power and return loss data) allows tor production of a real-world result for each cooking item. It also allows adjustment of the fitness function for irregularly sized and shaped food items (e.g. an object that is not uniform in shape, such as a chicken drumstick, may require more power to the bulk of its mass rather than its extremities to cook evenly without burning those areas of lower mass).

The above description deals with the analytical basis of providing an even (or profiled) cooking result. It has most application in solid state cooking devices due to the ease of phase and frequency agility to generate the RF parameters for the phased array applicator that leads to heating in a known position in the food. In addition, the practical case of the food cooking environment is approached by replacing ideal analytical mode patterns with heat pattern feedback control, obtained on the fly from IR camera data. An embodiment of the system has the capability of obtaining heat patterns from several camera positions to provide a more complete picture of cooking uniformity.

According to various embodiments, cameras are used to monitor the position of power within an oven cavity. Individual modes are then time-sliced during a cooking cycle so that a desired heating profile is achieved. More specifically, embodiments utilize variable time slicing and mode selection/determination in the cavity to sum the fields over time to achieve a desired cooking result. In addition, embodiments include developing food profiles for strangely shaped foods. Embodiments specifically provide a way for determining the position of power and then moving it to heat evenly. The combination of E field modes via variable time division multiplexing may allow for food to be cooked in desired heat patterns.

In contrast with the heating profile of FIG. 4, FIGS. 5 and 6 illustrate cooking profiles 500, 600 in which left and right, respectively, power skewing is applied on the same food item by applying different mode combinations for different time intervals. Implementation of embodiments of the present innovation show predictive control of power in pseudo realtime. (i.e., the cooking variable time multiplexing may be updated as the item is being cooked and its dielectric properties are changing).

Most solid state microwave oven reference designs present return loss bridges before the launch antennas. These launch antennas have been shown to be patch antennas or J/bent monopole antennas, or any number of traditional antennas (e.g., waveguide transitions and hairpin antennas). By using these return loss bridges, the frequency and/or phase space of a band of interest may be scanned, and determinations may be made regarding which frequencies and/or phases provide efficient points to which power can be injected into the oven.

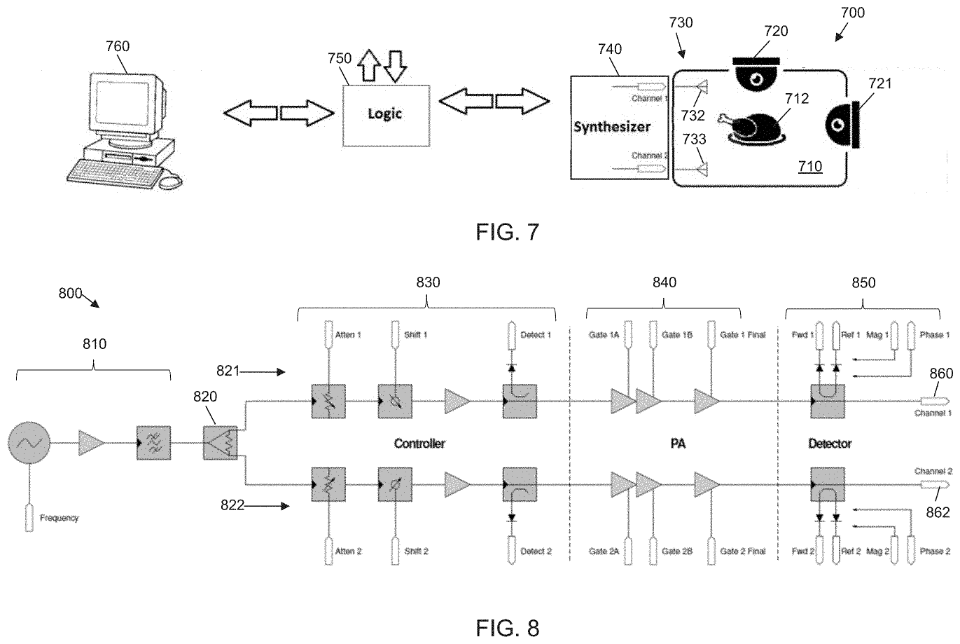

FIG. 7 illustrates a simplified depiction of a solid-state microwave cooking system 700, according to an embodiment. System 700 includes a cooking cavity 710 configured to contain a food load 712. A plurality of cameras 720, 721 (e.g., optical and/or IR cameras) and two elements 732, 733 of a phased array 730 are disposed in the cavity 710 (e.g., on walls of the cavity 710). System 700 also includes a synthesizer 740 coupled to the phased array elements 732, 733, a logic block 750, and a computer or embedded controller 760.

During operation, return loss in the cavity 710 is mapped against phase and frequency using the phased array 730. At the same time as mapping the phase and frequency, and according to an embodiment, one or more IR cameras (e.g., camera 720) are used to collect thermal images, and the images are used (e.g., by controller 760) to produce a map of the position of RF power (the E field mode position) in the cavity 710 at various instances of time. The return loss (efficiency) and position (mode position) correlation are used to time slice the cooking process using time division multiplexing.

According to an embodiment, one or more optical cameras (e.g., camera 721) are used to collect optical images of the food load 712, which may be analyzed (e.g., by controller 760) using optical recognition algorithms to determine food load condition (e.g., browning, etc.), food load shape, and/or food load volume. Although food load volume alternatively could be determined using a weight scale below the food load 712 (e.g., below a turntable within the cavity 710), food load shape recognition using the optical camera(s) 721 enable food load shape and approximate food load volume to be determined.

According to an embodiment, food load shape recognition information is used (e.g., by controller 760) to select E field data from IR and return loss mapping activities (discussed above) in order to determine cooking heat profiles that impinge the food load 712 via the variable time division multiplexing. The combination of E field modes via variable time division multiplexing allows for the food load 712 to be cooked in a desired heat pattern.

FIG. 7 shows two optical and/or IR cameras 720, 721 on the top cavity wall and the right cavity wall, respectively. In other embodiments, a single camera may be utilized, or more than two cameras may be utilized, and/or the cameras may be located in different positions within the cavity 710. Further, FIG. 7 illustrates a phased array 730 with two elements 732, 733 configured to direct electromagnetic energy into the cavity 710. In other embodiments, a phased array may be utilized with more than two elements.

FIG. 8 illustrates a schematic drawing of a synthesizer 800 (e.g., synthesizer 740, FIG. 7) with two channels 820, 821, according to an embodiment. Synthesizer 800 includes an RF signal generator 810, an RF signal splitter 820, a multi-channel variable attenuator and variable phase controller 830, a multi-channel, solid-state power amplifier (PA) 840, a multi-channel detector 850, and multiple outputs 860, 862.

The RF signal generator 810 is configured to produce an RF signal at a desired frequency (e.g., in a range of 2.4-2.5 GHz, or some other range). RF signal splitter 820 divides the RF signal produced by the RF signal generator 810 into multiple signals that are provided to the multiple channels 821, 822. Although synthesizer 800 is shown to include only two channels 820, 821, it should be understood that synthesizer 800 may include any number, n, of channels (e.g., 2≤n≤40 or more). Generally, the number of channels corresponds to the number of elements (e.g., elements 732, 733, FIG. 7) of the phased array (e.g., phased array 730, FIG. 7) within the cavity.

In each channel 821, 822, a variable attenuator and variable phase controller 830 applies a desired attenuation and/or a desired phase shift to the corresponding RF signal, which ultimately facilitates steering the electromagnetic energy within the cavity in a desired manner. Solid state power amplifier 840, which may be a single-stage amplifier or a multiple-stage amplifier (as shown), amplifies the corresponding RF signal produced by the controller 830. Detector 850 detects the forward and reverse RF signal along each channel 821, 822. Finally, an RF signal is produced along each channel 821, 822 at outputs 860, 862, each of which is coupled to a different element (e.g., elements 732, 733, FIG. 7) within the phased array (e.g., phased array 730, FIG. 7).

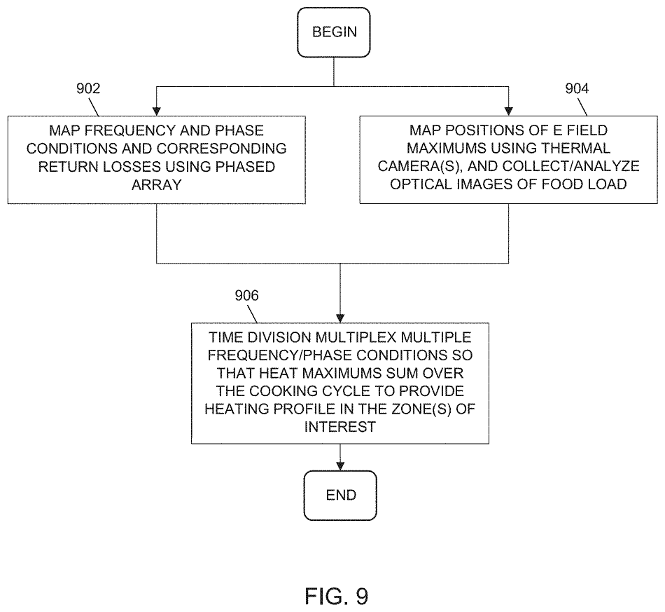

FIG. 9 illustrates a flowchart of a method for operating a solid-state microwave cooking system (e.g., system 700, FIG. 7), according to an embodiment. The method may begin, for example, after a food load (e.g., food load 712, FIG. 7) has been placed within the cavity (e.g., cavity 710, FIG. 7) of the system.

In block 902, return loss in the cavity (e.g., cavity 710, FIG. 7) is mapped against phase and frequency using the phased array (e.g., phased array 730, FIG. 7). In various embodiments, via a multiple-element phased array, a full map of the frequency and phase conditions and their corresponding return losses may be provided. This may be performed under a variety of cooking conditions from empty to loaded (food) in the cavity.

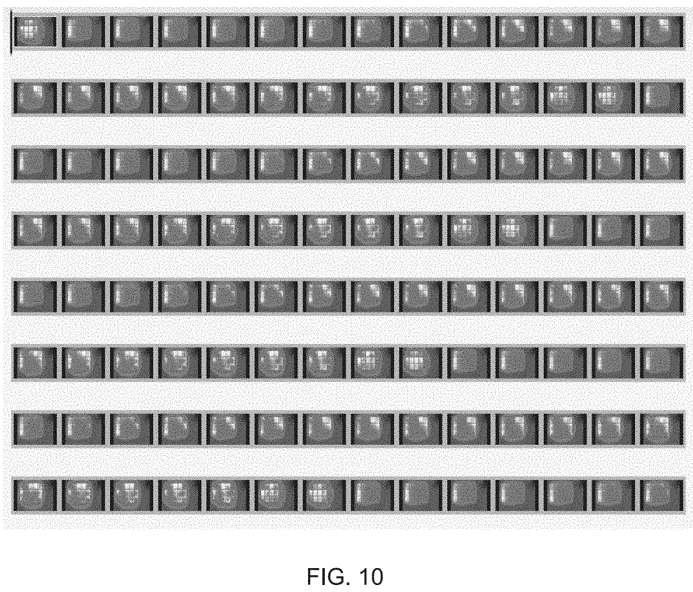

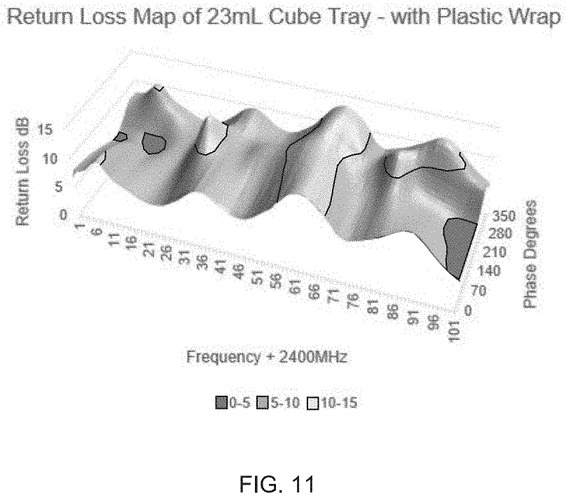

In block 904, which may be performed before, after, or simultaneously with block 902, one or more IR cameras (e.g., camera 720, FIG. 7) are used to collect thermal images, and the images are used (e.g., by controller 760, FIG. 7) to produce a map of the position of RF power (the E field mode position) in the cavity at an instance of time. In other words, the positions of the E field maximums also are mapped via the use of a thermal camera directed at the food load. For example, FIG. 10 illustrates a subset of an IR scan showing power (E field position) as a function of phase and frequency, and FIG. 11 illustrates a correlated return loss map as a function of phase and frequency. The return loss (efficiency) and position (mode position) correlation are used to time slice the cooking process using time division multiplexing.

According to an embodiment, one or more optical cameras (e.g., camera 721, FIG. 7) also are used to collect optical images of the food load, which may be analyzed (e.g., by controller 760) using optical recognition algorithms to determine food load condition (e.g., browning, etc.), food load shape, and/or food load volume, as discussed previously.

In block 906, which constitutes the main portion of the cooking process, multiple frequency phase conditions are time division multiplexed so that heat maximums sum over the cooking cycle to provide a desired heating profile in the zone(s) of interest. This may be a flat heating profile or importantly a profiled heating pattern to lead to appropriate heating of non-planar food structures. More particularly, food load shape recognition information is used (e.g., by controller 760) to select E field data from IR and return loss mapping activities in order to determine cooking heat profiles that impinge the food load via variable time division multiplexing. The combination of E field modes via variable time division multiplexing allows for the food load to be cooked in a desired heat pattern. Essentially, the process may involve steering (or shaping) the RF power using the phased array to produce a desired heating profile within the cavity. For example, the desired heating profile may correspond with the shape of the food load.

According to an embodiment, an example of a time division multiplexed cooking algorithm may be defined as:

F(time)=P1×t1×mode1+P2×t2×mode 2+P3×t3×mode3 (Equation 3)

where Pn are power levels during a time slice, tn is the length of the time slice, and mode n is the particular frequency/phase combination that leads to directing the electromagnetic energy (RF power) to a particular location in the cavity 710 (or on/within the food load 712). It should be pointed out that mode time slots may be variable. Once the cooking process has completed, the method ends.

Implementation of the various embodiments may provide one or more advantages over the use of conventional technologies. For example, implementation of an embodiment may facilitate predictive and deterministic control of power to a food item to achieve temperature profiles via the use of variable time division multiplexing. Implementation of an embodiment also may enable predictive determinations of whether a particular item can be cooked evenly (e.g., this may be useful for food recipe design). If no cooking equation can be found, the item to be cooked (e.g., recipe/food size) may be changed so that it can. The various embodiments also may provide an ability to design, on the fly, irregularly shaped temperature profiles to match irregularly shaped food items. Further, embodiments also may provide the ability to complement and correct for another form of co-located cooking (e.g., convection, etc.), which may itself have and irregularly shaped cooking profile.

The preceding detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

The connecting lines shown in the various figures contained herein are intended to represent exemplary functional relationships and/or physical couplings between the various elements. It should be noted that many alternative or additional functional relationships or physical connections may be present in an embodiment of the subject matter. In addition, certain terminology may also be used herein for the purpose of reference only, and thus are not intended to be limiting, and the terms “first”, “second” and other such numerical terms referring to structures do not imply a sequence or order unless clearly indicated by the context.

As used herein, a “node” means any internal or external reference point, connection point, junction, signal line, conductive element, or the like, at which a given signal, logic level, voltage, data pattern, current, or quantity is present. Furthermore, two or more nodes may be realized by one physical element (and two or more signals can be multiplexed, modulated, or otherwise distinguished even though received or output at a common node).

The foregoing description refers to elements or nodes or features being “connected” or “coupled” together. As used herein, unless expressly stated otherwise, “connected” means that one element is directly joined to (or directly communicates with) another element, and not necessarily mechanically. Likewise, unless expressly stated otherwise, “coupled” means that one element is directly or indirectly joined to (or directly or indirectly communicates with, electrically or otherwise) another element, and not necessarily mechanically. Thus, although the schematic shown in the figures depict one exemplary arrangement of elements, additional intervening elements, devices, features, or components may be present in an embodiment of the depicted subject matter.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method, performed by a microwave cooking system, of heating a food load, the method comprising the steps of:
mapping, using a phased array, frequency and phase conditions and corresponding return losses in a cavity of the microwave cooking system;
mapping, using one or more thermal cameras, positions of E field maximums in the cavity; and
time division multiplexing the frequency and phase conditions so that heat maximums sum over a cooking cycle to provide a heating profile in a zone of interest.
